(19) United States
(12) Patent Application Publication
(10) Pub. No.: US 2012/0275809 A1
(43) Pub. Date: Nov. 1, 2012

(54) Fixing unit and image forming apparatus

(75) Inventor: Sok-won Paik, Jeonju-si (KR)

(73) Assignee: SAMSUNG ELECTRONICS CO., LTD., Suwon-si (KR)

(21) Appl. No.: 13/317,508

(22) Filed: Oct. 20, 2011

(30) Foreign Application Priority Data
Apr. 27, 2011 (KR) 2011-0039315

(51) Int. Cl. G03G 15/20

(52) U.S. Cl. 399/69; 399/330; 399/334

(57) ABSTRACT

A fixing unit for use in an image forming apparatus includes a heating roller, the heating roller being divided into a fixing area and a non-fixing area, in which the fixing area is heated to above a target temperature required for fixing of an image, and the non-fixing area has a temperature lower than the target temperature, a main coil which generates a main magnetic field for generating an induced current, and at least one secondary coil which generates a secondary magnetic field to extend an area of the main magnetic field, where the fixing area of the heating roller, when formed by the main magnetic field, has a width smaller than an entire width of a maximum size paper, and the fixing area, when formed by a combination of the main magnetic field and the secondary magnetic field, is extendable to the entire width of the maximum size paper.

### CROSS-REFERENCE TO RELATED APPLICATIONS

This application claims priority from Korean Patent Application No. 10-2011-0039315, filed on Apr. 27, 2011, in the Korean Intellectual Property Office, the disclosure of which is incorporated herein by reference in its entirety.

### BACKGROUND

1. Field

Units consistent with the present disclosure relate to a fixing unit formed in an image forming apparatus, and more particularly, to a fixing unit including a heating roller which is heated by induced current.

2. Description of the Related Art

Image forming apparatus such as printers, copiers or facsimiles that use electrophotographic image forming method generally include a fixing unit which fixes a transferred developer image into a printing medium. Such fixing unit generally includes a heating roller and a pressing roller which are faced with each other with a fixing nip defined therebetween, so that an image is fixed into the printing medium by the heat and pressure of the rollers as the printing medium is passed through the fixing-nip.

The heating roller generates heat to fix the image, using heating resistance, heating lamp (e.g., halogen lamp) or induction heating member. The induction heating member generates heat as the induced current (or eddy current) is generated according to electromagnetic induction principle. When the induction heating member is used, at least one induction coil has to be provided so that induced current is generated by the induction heating member due to the electromagnetic field generated at the induction coil.

A printing medium may have left/right and/or upper/lower margin regions which are left unprinted. That is, images are not formed on the margins and thus an image fixing operation does not necessarily have to be carried out with respect to the margins.

However, a conventional heating roller is heated without considering the presence of margins, that is, the heating roller is heated in a manner so as to heat the entire area of the printing medium. Accordingly, conventionally, the entire area of the heating roller (i.e., area corresponding at least to the entire width of the printing medium) is heated to above a target temperature that is required for the fixation of an image.

Since even the margins of the printing medium are heated to a degree required for image fixation unnecessary, electricity is additionally consumed.

### SUMMARY

Exemplary embodiments overcome the above disadvantages and other disadvantages not described above. Also, the embodiments are not required to overcome the disadvantages described above, and an exemplary embodiment of the present inventive concept may not overcome any of the problems described above.

In one embodiment, electricity consumed for fixation of an image is reduced by reducing the heat transferred from a heating roller to margins of a printing medium during an image fixing operation.

In one embodiment, a fixing unit adapted for use in an image forming apparatus to fix an image on a printing medium is provided, which may include a heating roller which provides heat generated by induced current to the image on the printing medium, the heating roller being divided into a fixing area and a non-fixing area when the induced current is generated, in which the fixing area is heated to above a target temperature required for fixing of the image, and the non-fixing area has a temperature lower than the target temperature, a main coil which generates a main magnetic field for generating the induced current, and at least one secondary coil which generates a secondary magnetic field to extend an area of the main magnetic field, wherein the fixing area of the heating roller, formed by the main magnetic field, has a width smaller than an entire width of a maximum size printing medium which is printable by the image forming apparatus, and the fixing area of the heating roller, formed by a combination of the main magnetic field and the secondary magnetic field, is extendable to the entire width of the maximum size printing medium.

In one embodiment, an image forming apparatus having the fixing unit is provided.

The main coil may be extended along the heating roller while facing the heating roller.

The at least one secondary coil may include a left secondary coil which extends the fixing area of the heating roller to a left edge of the maximum size printing medium; and a right secondary coil which extends the fixing area of the heating roller to a right edge of the maximum size printing medium.

The fixing unit may additionally include a control unit which controls operation currents of the main coil, the left secondary coil and the right secondary coil.

The control unit may apply operation currents in the same direction as the direction of operation current of the main coil to the left and right secondary coils.

During fixing of an image onto the maximum size paper, the control unit may apply operation current to the left secondary coil only if actual left margin region set by a user is smaller than a predetermined left reference, and the control unit may apply the operation current to the right secondary coil only if actual right margin region set by the user is smaller than a predetermined right reference.

The left reference and the right reference may correspond to a default value of a left Margin region and a default value of a right margin region set at a document editing program.

The fixing area of the heating roller, formed by the main coil, may have a width corresponding to the width of the maximum size printing medium subtracted by the left reference and the right reference.

The fixing unit may additionally include at least one degaussing coil which degausses the main magnetic field generated by the main coil.

The at least one degaussing coil may include a left degaussing coil which degausses a left end of the main magnetic field, and a right degaussing coil which degausses a right end of the main magnetic field.

The left degaussing coil may be stacked on top of the left secondary coil, and the right degaussing coil may be stacked on top of the right secondary coil.

The fixing unit may additionally include a control unit which controls operation currents of the main coil, the left secondary coil, the right secondary coil, the left degaussing coil and the right degaussing coil.

In one embodiment, an image fixing method of a fixing unit adapted for use in an image forming apparatus to fix an image on a printing medium is provided, wherein the fixing unit may include a heating roller which provides heat generated by induced current to the image on the printing medium, the heating roller being divided into a fixing area and a non-fixing area when the induced current is generated, in which the fixing area is heated to above a target temperature required for fixing of the image, and the non-fixing area has a temperature lower than the target temperature, a main coil which generates a main magnetic field for generating the induced current, and at least one secondary coil which generates a secondary magnetic field to extend an area of the main magnetic field, wherein the fixing area of the heating roller, formed by the main magnetic field, has a width smaller than an entire width of a maximum size printing medium which is printable by the image forming apparatus, and the fixing area of the heating roller, formed by a combination of the main magnetic field and the secondary magnetic field, is extendable to the entire width of the maximum size printing medium, and the image fixing method may include operating the main coil, determining if the printing medium is the maximum size printing medium, and if the printing medium is the maximum size printing medium, comparing actual left and right margin regions set by a user with predetermined left and right references so that if the actual left or right margin region is smaller than the left or right reference, operating the left or right secondary coil.

If the printing medium is not the maximum size printing medium, the image fixing method may additionally include stopping operation of the left and right secondary coils without considering the actual left and right margin regions.

The fixing unit may additionally include a left degaussing coil which degausses a left area of the main magnetic field and a right degaussing coil which degausses a right area of the main magnetic field, and in this case, the fixing method may additionally include if the printing medium is not the maximum size printing medium, determining if the printing medium is of a specific size, and operating the left and right degaussing coils only if the printing medium is of the specific size.

The printing medium of the specific size may be a Monarch printing medium or an envelope printing medium.

### BRIEF DESCRIPTION OF THE DRAWINGS

The above and/or other aspects of what is described herein will be more apparent by describing certain exemplary embodiments with reference to the accompanying drawings, in which:

FIG. 1 is a schematic view of an image forming apparatus according to an embodiment;

FIG. 2 is a schematic perspective view of a fixing unit provided in the image forming apparatus of FIG. 1;

FIG. 3 is a side view of a heating roller of the fixing unit of FIG. 2 and also a temperature graph of the heating roller;

FIG. 4 is a side view of induction coils provided in the fixing unit of FIG. 2;

FIGS. 5 to 7 are views provided to explain control on the operation of the induction coils, in which FIG. 5 illustrates an example in which maximum size printing medium is used and left and right margin regions exceed left and right references, FIG. 6 illustrates an example in which maximum size printing medium is used and left and right margin regions are smaller than left and right references, and FIG. 7 illustrates an example where a printing medium other than maximum size printing medium is used, i.e., an example where a printing medium smaller than the maximum size printing medium is used;

FIG. 8 is a side view of induction coils provided in an electromagnetic generating unit according to a second embodiment;

FIG. 9 is a view provided to explain operation of the induction coils of FIG. 8;

FIG. 10 is a view illustrating an example of a printing medium having left and right margin regions as well as upper and lower margin regions; and

FIG. 11 is a schematic graph illustrating operation currents applied to the induction coils in accordance with time, during fixing of an image onto the printing medium of FIG. 10.

### DETAILED DESCRIPTION

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the disclosure with unnecessary detail.

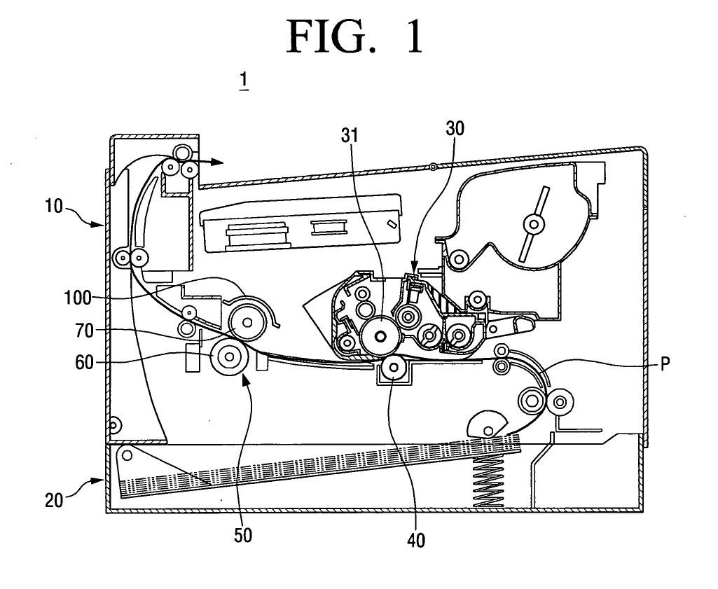

FIG. 1 is a schematic view of an image forming apparatus according to an embodiment.

Referring to FIG. 1, a laser printer is implemented as an example of an image forming apparatus 1. However, the present disclosure is not limited to this example only, and accordingly, those skilled in the art would be easily able to understand that the present disclosure is applicable to other apparatuses such as copiers, facsimiles, and multi-function units.

Referring to FIG. 1, the image forming apparatus 1 may include a main body 10 and a printing medium feeding unit 20 attached to a lower end of the main body 10. Inside the main body 10 are installed components including a developing unit 30 including an image bearing body 31, a transfer unit 40 and a fixing unit 50.

Regarding a conveyance path P of the printing medium, the printing medium picked up from the printing medium feeding unit 20 is passed in between the image bearing body 31 and the transfer unit 40, during which a developer image is transferred onto the printing medium. The developer image is then fixed into the printing medium at the fixing unit 50, and the printing medium is discharged out of the main body 10.

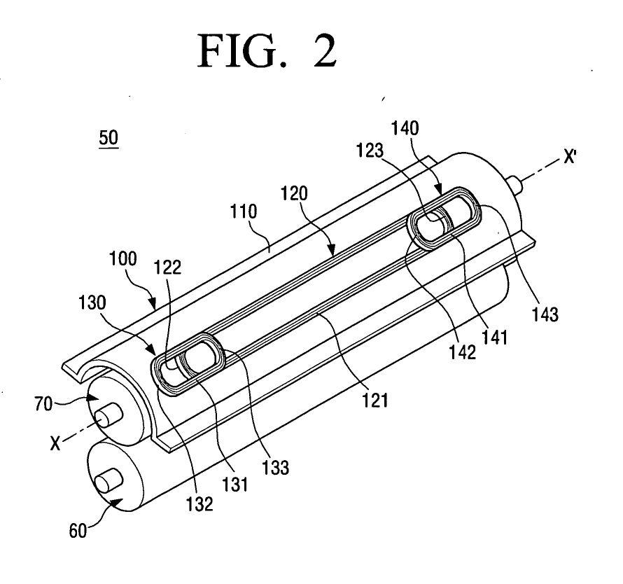

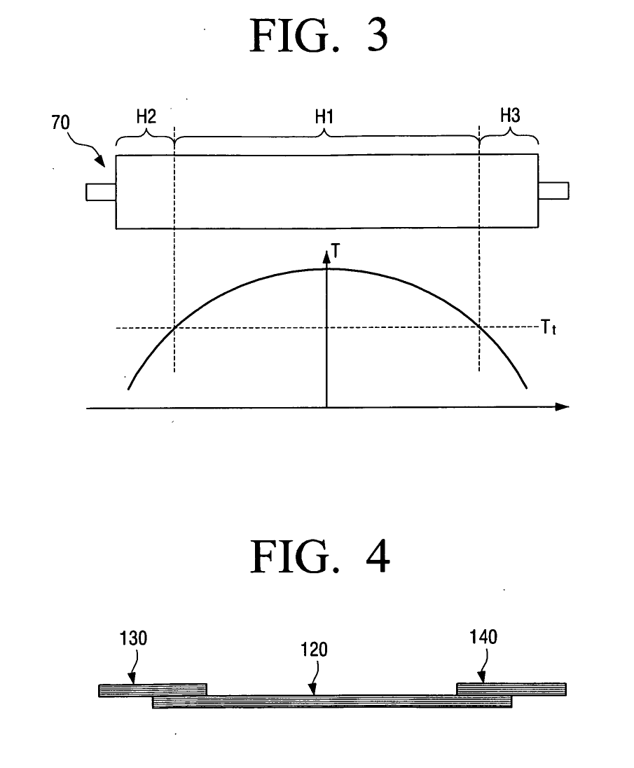

FIG. 2 is a schematic perspective view of a fixing unit provided in the image forming apparatus of FIG. 1, FIG. 3 is a side view of a heating roller of the fixing unit of FIG. 2 and also a temperature graph of the heating roller, and FIG. 4 is a side view of induction coils provided in the fixing unit of FIG. 2.

Referring to FIGS. 2 to 4, the fixing unit 50 may include a pressing roller 60, a heating roller 70, and an electromagnetic generating unit 100.

The pressing roller 60 is positioned to face the heating roller 70 and elastically biased toward the heating roller 70 by an elastic member (e.g., spring member) (not illustrated). Accordingly, the pressing roller 60 provides pressure necessary for fixing onto the printing medium passing through a fixing-nip defined between the pressing roller 60 and the heating roller 70.

The heating roller 70 is positioned to face the pressing roller 60 and provides heat necessary for fixing onto the printing medium passing through the fixing-nip. Accordingly, the heating roller 70 includes an induction heating member (not illustrated) as a heating means. In the present embodiment, the induction heating member is a nickel belt wrapping around the body of the heating roller 70. In alternate embodiments, the induction heating member may be metallic coils wound around the body of the heating roller 70.

During image fixation, induced current is generated on the induction heating member of the heating roller 70, and by the induced current, the heating roller 70 is able to generate heat required for fixing. Referring to FIG. 3, when induced current flows the induction heating member of the heating roller 70, an inner area (H1) of the heating roller 70 has a temperature that exceeds a target temperature (Tt) required for the image fixation, while outer areas (H2, H3) of the heating roller 70 has a temperature lower than the target temperature (Tt).

The ‘target temperature (Tt)’ herein is defined as a minimum temperature that is required for fixation of an image. Accordingly, while an image fixation is processed on an area of the printing medium which contacts the inner area (H1) with the temperature exceeding the target temperature (Tt), image is hardly fixed on an area of the printing medium which contacts the outer areas (H2, H3) with the temperature lower than the target temperature (Tt).

For convenience of explanation, the inner area (H1) of the heating roller 70 is referred to as “fixing area (H1)”, and the outer areas (H2, H3) of the heating roller 70 are referred to as “non-fixing area (H2, H3)”, respectively.

As illustrated in FIG. 2, the electromagnetic generating unit 100 may include a support member 110, a main coil 120, and left/right secondary coils 130, 140.

The supporting member 110 is arranged to surround an upper portion of the heating roller 70 which is positioned therebelow, and a main coil 120 and secondary coils 130, 140 are mounted on an outer surface of the supporting member 110.

The main coil 120 generates main magnetic field to generate induced current on the induction heating member, and the secondary coils 130, 140 generate secondary magnetic field to assist the main magnetic field so that the area of the main magnetic field can be extended. Accordingly, by the main magnetic field of the main coil 120, or by a combination of the main magnetic field of the main coil 120 and the secondary magnetic field of the secondary coils 130, 140, induced current can be generated on the induction heating member (not illustrated) of the heating roller 70.

The main coil 120 is implemented as a wire made from a metallic material (e.g., copper) which is wound several tens of times. The main coil 120 is extended along the heating roller 70 to face the heating roller 70. That is, the main coil 120 is arranged in a substantially parallel to an axis of rotation (X-X′) of the heating roller 70. Referring to FIG. 2, the main coil 120 has a substantially track shape, and includes a linear portion 121 substantially parallel to the axis of rotation (X-X′) of the heating roller 70, and curved portions 122, 123 extended from both ends of the linear portion 121. As shown in FIG. 2, the curved portions 122, 123 include left curved portion 122 and right curved portion 123.

During operation of the main coil 120, the area of the heating roller 70 corresponding to the linear portion 121 of the main coil 120 is heated to the temperature above the target temperature (Tt) (FIG. 3). However, it is empirically confirmed that the area of the heating roller 70 that correspond to the curved portions 122, 123 of the main coil 120 have a temperature lower than the target temperature (Tt). This is be because while the linear portion 121 of the main coil 120 generates sufficient magnetic field to heat the heating roller 70 above the target temperature (Tt), the curved portions 122, 123 of the main coil 120 do not generate enough magnetic field to heat the heating roller 70 above the target temperature (Tt).

If the main coil 120 is operated, but the secondary coils 130, 140 are not operated, i.e., if the operation current is applied to the main coil 120, but not to the secondary coils 130, 140, the fixing area (H1) (see FIG. 3) of the heating roller 70 is formed only by the main magnetic field of the main coil 120. As explained above, since the area of the heating roller 70 corresponding to the linear portion 121 of the main coil 120 can be heated to above the target temperature (Tt), the width of the fixing area (H1) of the heating roller 70 substantially corresponds to the length of the linear portion 121 of the main coil 120. Therefore, if only the main coil 120 is operated, it can be seen that the width of the fixing area (H1) of the heating roller 70 substantially corresponds to the length of the linear portion 121 of the main coil 120.

A conventional general image forming apparatus is generally designed so that the length of the linear portion of the main coil exceeds the width of the maximum size printing medium printable by the image forming apparatus, and in this case, a fixing area exceeding the width of the maximum size printing medium can be formed on the heating roller only by the main coil.

The image forming apparatus 1 is designed so that the length of the linear portion 121 of the main coil 120 is less than the width of the maximum size printing medium printable by the image forming apparatus 1. Accordingly, the fixing area (H1) of the heating roller 70 formed by the main coil 120 has a less width than the width of the maximum size printing medium.

Generally, there are upper/lower and left/right margin regions designated on a printing medium during printing. Since there is no image on the margin regions, image fixation is not required on these margin regions. Based on this characteristic, the linear portion 121 of the main coil 120 is designed to have a length in which sizes of conventional left and right margin regions are subtracted from an entire width the maximum size printing medium. Herein, the sizes of the conventional left margin regions and the conventional right margin regions considered during designing of the main coil 120 are defined as “left reference” and “right reference”, respectively.

Further, the left/right margin regions designated by the user may have approximately similar values as the default values of the left/right margins set at specific document-editing processors (e.g., MS-Word or Hunminjeongeum). Considering this, the left reference and the right reference may be set as values close to conventional default values of the left/right margin regions. For example, the left and right references may be selected from a range between 20 mm and 35 mm, respectively.

By way of example, if the left and right references are set to 30 mm during the manufacturing of the image forming apparatus 1, the linear portion 121 of the main coil 120 may be designed to have a length 60 mm short of the width of the maximum size printing medium, so that the width of the fixing area (H1) (see FIG. 3) formed by the main coil 120 is formed 60 mm short of the width of the maximum size printing medium.

The width of the fixing area (H1) formed by the main coil 120 is smaller than the width of the maximum size printing medium. However, if the actual left/right margins designated by the user are not smaller than the left and right references explained above, the fixing area (H1) of the heating roller 70 can be formed with a sufficient width to process the image fixation by only the main coil 120.

As explained above, the main coil 120 has the linear portion 121 with a length smaller than the width of the maximum size printing medium. Accordingly, the main coil 120 has a size smaller than the prior art conventional main coil. As a result, material cost for the manufacture of the main coil 120 as well as electric power required for driving the main coil 120 can be reduced.

As explained above with reference to FIGS. 2 and 4, the left and right secondary coils 130, 140 are arranged on left and right sides of the main coil 120, respectively. To be specific, the left and right secondary coils 130, 140 are stacked on a left end 122 and a right end 123 of the main coil 120. The left and right secondary coils 130, 140 may be implemented as wires made from the same material as the main coil 120 which are wound from several to several tens of times. The left and right secondary coils 130, 140 are arranged in a substantially parallel relationship with respect to the axis of rotation X-X′ of the heating roller 70.

As illustrated in FIG. 2, the left secondary coil 130 has a track shape, and includes the linear portion 131 parallel to the axis of rotation X-X′ and the curved portions 132, 133 extended from both ends of the linear portion 121. Similarly to the left secondary coil 130, the right secondary coil 140 has a track shape, and includes a linear portion 141 parallel to the axis of rotation X-X′ and the curved portions 142, 143 extended from both ends of the linear portion 141. As shown in FIG. 2, the curved portions 132, 133, 142, 143 include left curved portions 132, 142 and right curved portions 133, 143.

The direction of electric currents applied to the left and right secondary coils 130, 140 are same as the direction of electric current applied to the main coil 120. Therefore, the main magnetic field formed by the main coil 120 can be extended due to the secondary magnetic field formed by the left and right secondary coils 130, 140.

As explained above, the fixing area (H1) formed by the main magnetic field of the main coil 120 is shorter as much as the left and right references, and if the actual left and right margins set by the user are larger than the left and right references, the fixing area (H1) formed only by the main coil 120 has a sufficient size required for the fixing of an image.

However, if the actual left margin region set by the user is smaller than the left reference or if the actual right margin region set by the user is smaller than the right reference, the fixing area (H1) formed by the main coil 120 cannot have a sufficient size required for the fixing of an image. In such a case, the left secondary coil 130 and/or right secondary coil 140 is operated to assist the main coil 120.

By way of example, if the left and right references are 30 mm, respectively, and the actual left and right margins as set by the user are 10 mm, respectively, since the actual left and right margin regions are smaller than the left and right references, both of the left and right secondary coils 130, 140 are operated. Accordingly, the fixing area (H1) of the heating roller 70 is formed by a combination of the main magnetic field of the main coil 120 and the secondary magnetic field of the left and right secondary coils 130, 140, so that the width of the fixing area (H1) is extended at least to the extent of the entire width of the maximum size printing medium.

As an another example, if the left and right references are 30 mm, respectively, and the actual left and right margins as set by the user are 10 mm and 40 mm, respectively, since the actual left margin region is smaller than the left reference, the left secondary coil 130 is operated. However, since the actual right margin region is larger than the right reference, the right secondary coil 130 is not operated. Accordingly, the fixing area (H1) of the heating roller 70 is formed by a combination of the main magnetic field of the main coil 120 and the secondary magnetic field of the left secondary coil 130, so that the width of the fixing area (H1) is extended at least to the left end of the maximum size printing medium.

As an another example, if the left and right references are 30 mm, respectively, and the actual left and right margin regions as set by the user are 40 mm and 10 mm, respectively, since the actual left margin region is larger than the left reference, the left secondary coil 130 is not operated. However, since the actual right margin is smaller than the right reference, the right secondary coil 140 is operated. Accordingly, the fixing area (H1) of the heating roller 70 is formed by a combination of the main magnetic field of the main coil 120 and the secondary magnetic field of the right secondary coil 140, so that the width of the fixing area (H1) is extended at least to the right end of the maximum size printing medium.

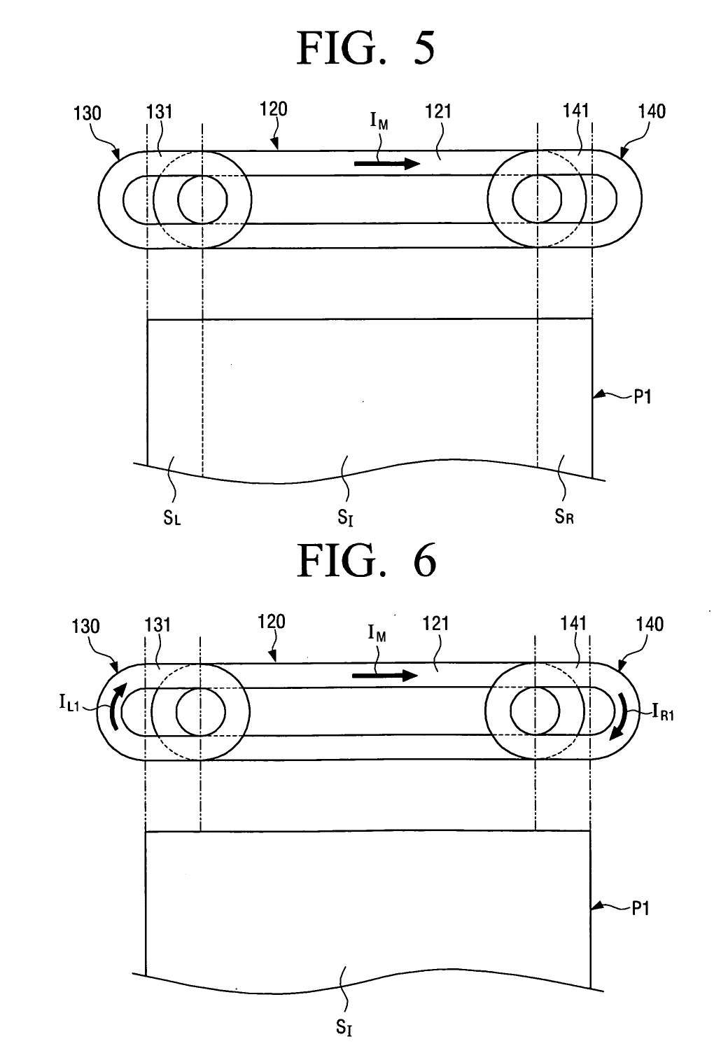

The fixing unit 50 further comprises a control unit (e.g., inverter) (not illustrated) to control the operation currents applied to the main coil 120 and the secondary coils 130, 140. Depending on the size of the printing medium and also depending on the actual left and right margin regions designated for the printing medium, the control unit controls the currents applied to the main coil 120 and the secondary coils 130, 140. This will be explained in greater detail below with reference to FIGS. 5 to 7.

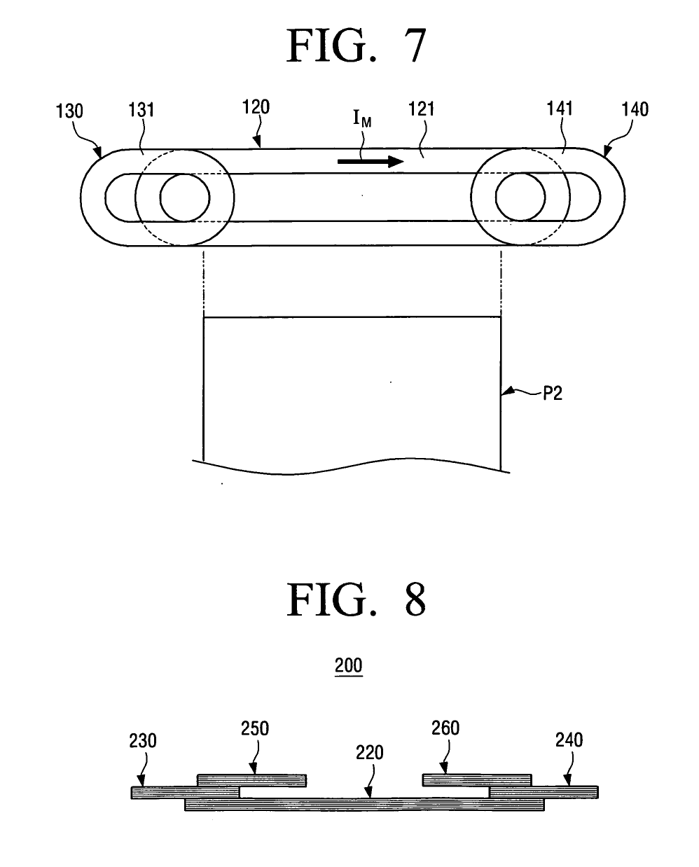

FIGS. 5 to 7 are views provided to explain control on the operation of the induction coils, in which FIG. 5 illustrates an example in which maximum size printing medium is used and left and right margin regions exceed left and right references, FIG. 6 illustrates an example in which maximum size printing medium is used and left and right margin regions are smaller than left and right references, and FIG. 7 illustrates an example where a printing medium other than maximum size printing medium is used, i.e., an example where a printing medium smaller than the maximum size printing medium is used.

Herein, the ‘maximum size printing medium’ refers to a maximum size printing medium that can be printed by the image forming apparatus 1, and in this embodiment, it is assumed that A4 printing medium is the maximum size printing medium. It is also assumed that the left and right references are 30 mm, respectively.

As the printing begins, the control unit applies operation current I_{M} to the main coil 120, irrespective of the size of the printing medium. In other words, irrespective of whether the printing medium is A4 or smaller than that, the main coil 120 is always operated in the fixing operation.

The control unit then determines if the printing medium is the maximum size printing medium.

If the printing medium is not the maximum size printing medium (i.e., A4 paper), the control unit does not operate the secondary coils 130, 140, without considering the sizes of the actual left/right margin regions. That is, the control unit does not apply the operation currents to the secondary coils 130, 140.

For example, referring to FIG. 7, if the printing medium P2 is a smaller-size printing medium (e.g., B5, A5, US Folio, etc.) than the maximum size paper (i.e., A4 paper), the control unit applies the operation current I_{M} only to the main coil 120. As explained above, if the printing medium P2 is smaller than the maximum size printing medium, the fixing area (H1) of the heating roller 70, which is formed only by the main magnetic field of the main coil 120, can have a width sufficient to fix image on the entire area of the printing medium P2.

If the printing medium is the maximum size printing medium (i.e., A4 paper), the control unit compares the actual left/right margin regions with the left/right references.

For example, referring to FIG. 5, if the actual left/right margin regions (S_{L}, S_{R}) are 40 mm, respectively, and thus are larger than the left/right references (i.e., 30 mm), the control unit does not operate the left/right secondary coils 130, 140, while keeping applying the operation current (I_{M}) to the main coil 120. As explained above, if the actual left/right margin regions (S_{U} S_{R}) are larger than the left/right references, the width of the fixing area (H1) of the heating roller 70 formed by the main coil 120 exceeds the width of the image area (S_{I}) of the maximum size paper (P1). Accordingly, even though the left/right secondary coils 130, 140 are not operated, image fixing can be processed with respect to the image area (S_{I}) of the maximum size printing medium (P1).

Referring to FIG. 6, if the actual left/right margins (S_{L}, S_{R}) are 0 mm, respectively, and thus are smaller than the left/right references (i.e., 30 mm), the control unit keeps applying the operation current (I_{M}) to the main coil 120, and also keeps applying the operation currents (I_{L1}, I_{R1}) to the left/right secondary coils 130, 140. As explained above, the direction of the operation currents (I_{L1}, I_{R1}) to the secondary coils 130, 140 is same as the direction of the operation current (I_{M}) to the main coil 120. Since the operation currents (I_{L1}, I_{R1}) are applied also to the left/right secondary coils 130, 140, the fixing area (H1) of the heating roller 70 is formed by a combination of the main magnetic field of the main coil 120 and the secondary magnetic field of the secondary coils 130, 140, and as a result, the width of the fixing area (H1) of the heating roller 70 is extended to a size corresponding to the entire width of the maximum size printing medium (P1). Accordingly, the image can be fixed onto the entire area of the maximum size printing medium (P1).

Meanwhile, if the actual left margin (S_{L}) is 10 mm and thus is smaller than the left reference (i.e., 30 mm) and the actual right margin (S_{R}) is 40 mm and thus is larger than the right reference (i.e., 30 mm), the control unit operates the left secondary coil 130, but does not operate the right secondary coil 140. Conversely, if the actual left margin (S_{L}) is 40 mm and thus is larger than the left reference (i.e., 30 mm) and the actual right margin (S_{R}) is 10 mm and thus is smaller than the right reference (i.e., 30 mm), the control unit does not operate the left secondary coil 130, but operates the right secondary coil 140. In the above-explained manner, the control unit controls the left/right secondary coils 130, 140 independently from each other.

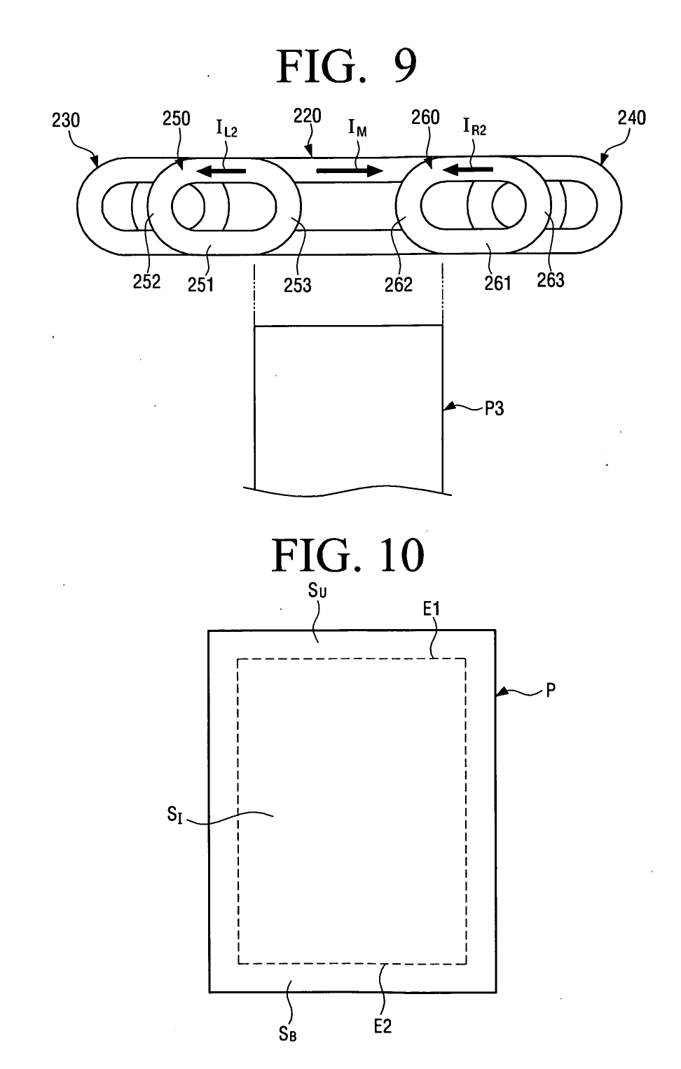

FIG. 8 is a side view of induction coils provided in an electromagnetic generating unit according to a second embodiment, and FIG. 9 is a view provided to explain operation of the induction coils of FIG. 8.

Referring to FIGS. 8 and 9, the magnetic generating unit 200 according to a second embodiment has a main coil 220 and left/right secondary coils 230, 240, which is similar to the example of the magnetic generating unit 100 explained above (see FIG. 2). However, the magnetic generating unit 200 of the second embodiment further comprises left/right degaussing coils 250, 260.

Referring to FIG. 8, the left/right degaussing coils 250, 260 are stacked on the left/right secondary coils 230, 240, respectively. Accordingly, the left/right degaussing coils 250, 260 operate to partially degaussing the main magnetic field formed by the main coil 220. That is, the left/right degaussing coils 250, 260 operate as degaussing coils. By the degaussing coils 250, 260, the fixing area (H1) of the heating roller 70 formed by the main coil 220 can be reduced.

Referring to FIG. 9, the left degaussing coil 250 has a track shape, and includes a linear portion 251 and curved portions 252, 253. Likewise, the right degaussing coil 260 also includes a linear portion 261 and curved portions 262, 263.

If printing is processed using a printing medium (P3) such as Monarch paper or envelope which is considerably smaller than the maximum size printing medium (i.e., A4 paper), the control unit of the fixing unit 50 applies the operation currents (I_{L2}, I_{R2}) which are in opposite direction to the operation current (I_{M}) of the main coil 220 to the left/right degaussing coils 250, 260.

Accordingly, the main magnetic field formed by the main coil 220 can be degaussed by the magnetic field formed by the left/right degaussing coils 250, 260. Accordingly, the width of the fixing area (H1) formed on the heating roller 70 can also be reduced. To be specific, the width of the fixing area (H1) of the heating roller 70 can be reduced as much as the sum of the linear portions 251, 261 of the left/right degaussing coils 250, 260.

Due to the degaussing of magnetic field by the left/right degaussing coils 250, 260, the fixing area (H1) of the heating roller 70 can be reduced to an extent that is suitable for printing on the very small size printing medium (P3). Accordingly, unnecessary consumption of electric power for heating of the heating roller 70 can be saved.

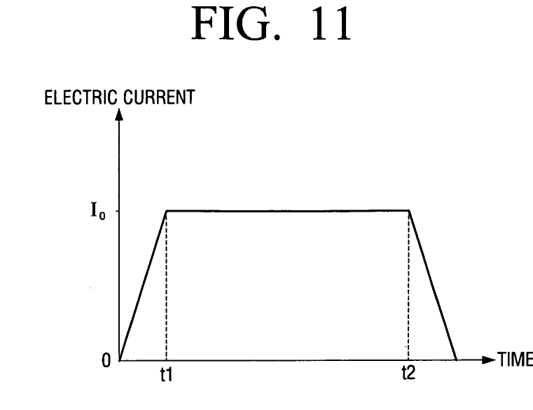

FIG. 10 is a view illustrating an example of a printing medium having left/right margin regions and upper/lower margin regions, and FIG. 11 is a schematic graph illustrating operation currents applied to the induction coils in accordance with time, during fixing of an image onto the printing medium of FIG. 10.

Referring to FIG. 10, the printing medium (P) may have not only left/right margin regions (S_{L}, S_{R}) (see FIG. 5), but also upper/lower margin regions (S_{U}, S_{B}). Like the left/right margin regions (S_{L}, S_{R}), the upper/lower margin regions (S_{U}, S_{B}) are the areas where no image is formed.

Referring to FIG. 11, during image fixing onto the printing medium (P) of FIG. 10, the control unit of the fixing unit 50 controls so that the operation current is not applied to the induction coils explained above as long as the upper/lower margin regions (S_{U}, S_{B}) pass the fixing-nip. That is, based on an assumption that the operation current necessary for the above-explained induction coils is I_{O}, the operation current reaches I_{O} at a moment when the leading edge (E1) of the image area (S_{I}) passes the fixing-nip, and the operation current of the induction coils varies to below I_{O} at a moment when a trailing edge (E2) of the image area (S_{I}) passes the fixing-nip.

Since the control unit of the fixing unit 50 operates as explained above with reference to FIG. 11, unnecessary consumption of electric power for heating of the upper/lower margin regions (S_{U}, S_{B}) of the printing medium (P) can be prevented. As a result, electricity consumption during image fixing process can be reduced.

As explained above, since the length of the main coil can be reduced compared to that of prior art, material cost consumed for the induction coils of the fixing unit can be reduced.

Further, according to the above embodiments, since the induction coils are operated appropriately in consideration of the size of the printing medium and the margin regions designated on the printing medium, electric power consumption for fixing of an image can be reduced compared to that of prior art.

The foregoing exemplary embodiments and advantages are merely exemplary and are not to be construed as limiting the present inventive concept. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A fixing unit adapted for use in an image forming apparatus to fix on image on a printing medium, the fixing unit comprising:
a heating roller which provides heat generated by induced current to the image on the printing medium, the heating roller being divided into a fixing area and a non-fixing area when the induced current is generated, in which the fixing area is heated to above a target temperature required for fixing of the image, and the non-fixing area has a temperature lower than the target temperature;
a main coil which generates a main magnetic field for generating the induced current; and
at least one secondary coil which generates a secondary magnetic field to extend an area of the main magnetic field,
wherein the fixing area of the heating roller, formed by the main magnetic field, has a width smaller than an entire width of a maximum size printing medium which is printable by the image forming apparatus, and the fixing area of the heating roller, formed by a combination of the main magnetic field and the secondary magnetic field, is extendable to the entire width of the maximum size printing medium.

2. The fixing unit of claim 1, wherein the main coil is extended along the heating roller while facing the heating roller.

3. The fixing unit of claim 2, wherein the at least one secondary coil comprises:
a left secondary coil which extends the fixing area of the heating roller to a left edge of the maximum size printing medium; and
a right secondary coil which extends the fixing area of the heating roller to a right edge of the maximum size printing medium.

4. The fixing unit of claim 3, further comprising a control unit which controls operation currents of the main coil, the left secondary coil and the right secondary coil.

5. The fixing unit of claim 4, wherein the control unit applies operation currents in the same direction as the direction of operation current of the main coil to the left and right secondary coils.

6. The fixing unit of claim 4, wherein during fixing of an image onto the maximum size paper, the control unit applies operation current to the left secondary coil only if an actual left margin region set by a user is smaller than a predetermined left reference, and the control unit applies the operation current to the right secondary coil only if an actual right margin region set by the user is smaller than a predetermined right reference.

7. The fixing unit of claim 6, wherein the left reference and the right reference correspond to a default value of a left margin region and a default value of a right margin region set at a document editing program.

8. The fixing unit of claim 6, wherein the fixing area of the heating roller, formed by the main coil, has a width corresponding to the width of the maximum size printing medium subtracted by the left reference and the right reference.

9. The fixing unit of claim 3, further comprising at least one degaussing coil which degausses the main magnetic field generated by the main coil.

10. The fixing unit of claim 9, wherein the at least one degaussing coil comprises:
a left degaussing coil which degausses a left end of the main magnetic field; and
a right degaussing coil which degausses a right end of the main magnetic field.

11. The fixing unit of claim 10, wherein the left degaussing coil is stacked on top of the left secondary coil, and the right degaussing coil is stacked on top of the right secondary coil.

12. The fixing unit of claim 10, further comprising a control unit which controls operation currents of the main coil, the left secondary coil, the right secondary coil, the left degaussing coil and the right degaussing coil.

13. The fixing unit of claim 3, wherein the main coil, the left secondary coil and the right secondary each have a track shape including a linear portion parallel to an axis of rotation of the heating roller and left and right curved portions extended from both ends of the linear portion, respectively.

14. The fixing unit of claim 13, wherein the left secondary coil and the right secondary coil are stacked above the main coil.

15. An image forming apparatus comprising a fixing unit to fix an image on a printing medium, the fixing unit comprising,
a heating roller which provides heat generated by induced current to the image on the printing medium, the heating roller being divided into a fixing area and a non-fixing area when the induced current is generated, in which the fixing area is heated to above a target temperature required for fixing of the image, and the non-fixing area has a temperature lower than the target temperature,
a main coil which generates a main magnetic field for generating the induced current, and
at least one secondary coil which generates a secondary magnetic field to extend an area of the main magnetic field,
wherein the fixing area of the heating roller, formed by the main magnetic field, has a width smaller than an entire width of a maximum size printing medium which is printable by the image forming apparatus, and the fixing area of the heating roller, formed by a combination of the main magnetic field and the secondary magnetic field, is extendable to the entire width of the maximum size printing medium.

16. An image fixing method of a fixing unit adapted for use in an image forming apparatus to fix an image on a printing medium, wherein the fixing unit comprises a heating roller which provides heat generated by induced current to the image on the printing medium, the heating roller being divided into a fixing area and a non-fixing area when the induced current is generated, in which the fixing area is heated to above a target temperature required for fixing of the image, and the non-fixing area has a temperature lower than the target temperature, a main coil which generates a main magnetic field for generating the induced current, and at least one secondary coil which generates a secondary magnetic field to extend an area of the main magnetic field, wherein the fixing area of the heating roller, formed by the main magnetic field, has a width smaller than an entire width of a maximum size printing medium which is printable by the image forming apparatus, and the fixing area of the heating roller, formed by a combination of the main magnetic field and the secondary magnetic field, is extendable to the entire width of the maximum size printing medium, the image fixing method comprising:
operating the main coil;
determining if the printing medium is the maximum size printing medium; and
if the printing medium is the maximum size paper, comparing actual left and right margin regions set by a user with predetermined left and right references so that if the actual left or right margin is smaller than the left or right reference, operating the left or right secondary coil.

17. The image fixing method of claim 16, further comprising:
if the printing medium is not the maximum size paper, stopping operation of the left and right secondary coils without considering the actual left and right margin regions.

18. The image fixing method of claim 17, wherein the fixing unit further comprise a left degaussing coil which degausses a left area of the main magnetic field and a right degaussing coil which degausses a right area of the main magnetic field, and
the image fixing method further comprises:
if the printing medium is not the maximum size printing medium, determining if the printing medium is of a specific size, and
operating the left and right degaussing coils only if the printing medium is of the specific size.

19. The image fixing method of claim 18, wherein the printing medium of the specific size is a Monarch printing medium or an envelope printing medium.
